(19) United States
(12) Patent Application Publication
(10) Pub. No.: US 2015/0056018 A1
(43) Pub. Date: Feb. 26, 2015

(54) DRIVE-OVER BERM FOR A CONTAINMENT SYSTEM AND METHOD OF CONSTRUCTION

(71) Applicant: Johnston-Morehouse-Dickey Company (a/k/a JMD Company), Bethel Park, PA (US)

(72) Inventor: Scott E. Forse, Venetia, PA (US)

(73) Assignee: Johnston-Morehouse-Dickey Company (a/k/a JMD Company), Bethel Park, PA (US)

(21) Appl. No.: 13/970,716

(22) Filed: Aug. 20, 2013

(51) Int. Cl. B65D 90/24; B29C 65/02; E02B 8/00

(52) U.S. Cl. CPC B65D 90/24; E02B 8/00; B29C 65/02; B29K 2105/256
USPC 405/114; 156/303.1; 29/428

(57) ABSTRACT

A drive-over berm for use with a protective liner. The berm is constructed of an elongate border sheet strip of a liquid-impermeable material having a berm sleeve along an outside elongate edge and an apron along an elongate inside edge for sealed securement to an underlying liquid-impermeable protective liner. A series of unconnected elongate resilient berm log segments are slidably received in the sleeve and exposed outer surfaces of the sleeve are provided with a high visibility color.

### BACKGROUND OF THE INVENTION

The present invention pertains to hazardous containment systems which incorporate liners that protect the environment from spills and leaks at sites, such as oil and gas well drilling sites, and more particularly, relates to berms for use with such liners.

In gas and oil drilling operations, drilling companies are required to construct containment pads at the drilling site for containing hazardous materials and liquids, such as drilling mud, fracturing chemicals and flow back water on the site. This is accomplished by placing a liquid impervious liner over the entire drilling site surface and the liner is laid over earthen berms, railroad ties, corrugated pipe or foam blocks to form containments, sidewalls or berms around the perimeter. For example, see the drive-over berm system disclosed in US Patent Application Publication No. 2013/0121768, entitled BERMS FOR PROTECTIVE LINERS. The liner and berms contain the leaks and spills so that the waste can be removed without impact on the environment.

Drive-over berm systems which are prefabricated and shipped to the drilling site for use with protective liners are desirable for easy assembly, transportation and storage purposes and they permit large vehicles to access interior portions of the containment pad or system. However, drive-over berms presently available on the market have deficiencies in that they cannot be preassembled before shipping and they are expensive to manufacture, and require excessive labor and time to assemble at the drilling site as the multiple sections of the berms' logs must be connected end to end, and then must be inserted into the sleeve tunnels of the berm covering strip which is subsequently shaped and then sealed to the underlying liner, such as by heat welding. The preconstructed berm assemblies or systems of the prior art are not capable of being preassembled in long lengths of 40 feet or more which can also be folded in an assembled condition for easy storage and shipment.

### SUMMARY OF THE INVENTION

The hazardous containment system of the present invention include a drive-over berm secured and sealed to the perimeter edge of a liquid-impermeable liner to thereby provide a hazardous containment pad. The berm includes an elongate border sheet strip of a liquid-impermeable material having a berm sleeve along an outside elongate edge and an apron along an elongate inside edge, which apron is in liquid sealed securement to the underlying liner. A series of unconnected elongate resilient berm log segments are slidably received in the sleeve.

The preassembled drive-over berm is prepackaged for shipment to the drilling site by folding the berm back and forth on itself at gaps provided between adjacent log segments and then bundled or banded in this preassembled folded condition for easy storage and shipment.

The spacing between adjacent log segments may be readjusted at the drilling site and corners are formed in the preassembled berm at selected gaps provided between the adjacent log segment and the berm apron is then heat sealed to the underlying liner. The exterior perimeter of the berm is secured to the underlying ground by driving anchoring pins through grommets provided in the outside perimeter.

For safety purposes, external exposed surfaces of the berm are of a high visibility color, such as white, yellow or blaze orange.

The resilient berm log segments are preferably composed of a plastic foam, but may be alternatively constructed of unconnected elongate segments of an extruded plastic product which will flexibly collapse under the weight of a vehicle, yet rebound to its original configuration.

### BRIEF DESCRIPTION OF THE DRAWINGS

Other objects and advantages appear hereinafter in the following description and claims. The accompanying drawings show, for the purpose of exemplification, without limiting the scope of the present invention or the appended claims, certain practical embodiments of the present invention wherein:

FIG. 1 is a schematic top plan view of a liner and berm assembly providing a containment system in accordance with the teachings of the present invention;

FIG. 2 is a sectional view illustrating a portion of the berm assembly as shown in FIG. 1 as seen along section line II-II; and

FIG. 3 is a sectional view of the berm assembly illustrating a different embodiment of the present invention.

### DETAILED DESCRIPTION OF PREFERRED EMBODIMENTS

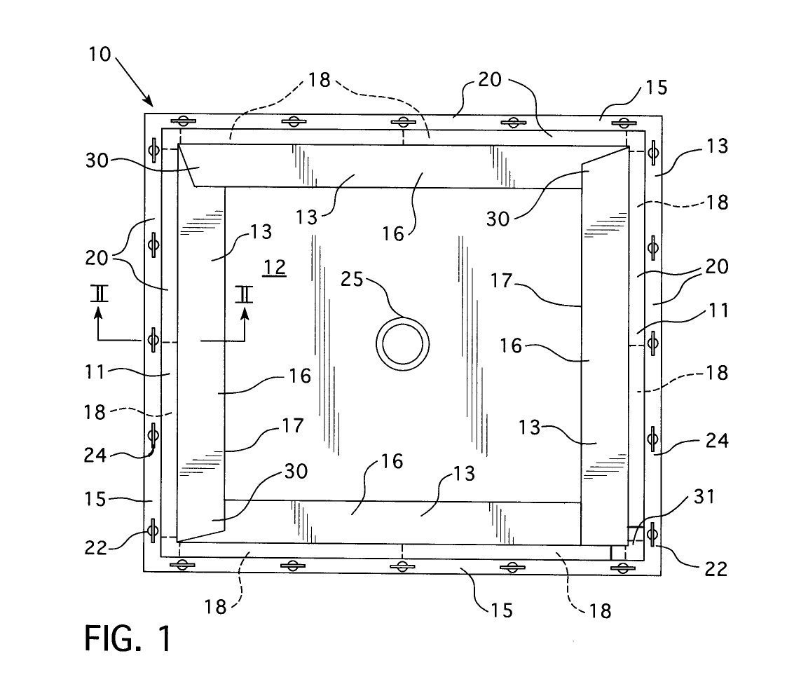

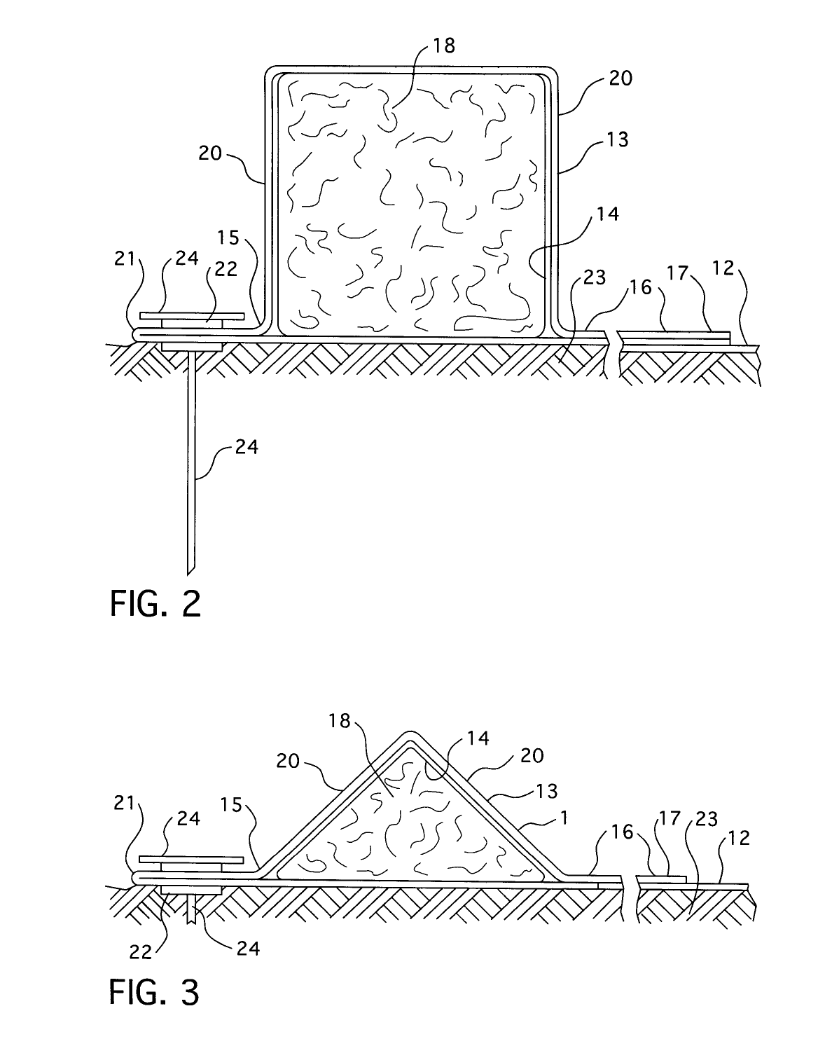

Referring to FIGS. 1 and 2, the hazardous liquid containment system 10 of the present invention is illustrated and includes a liquid-impermeable liner 12 having a drive-over berm 11 secured to the perimeter edge of liner 12 to thereby provide in combination a hazardous containment pad. The berm 11 includes an elongate border sheet strip 13 of a liquid-impermeable yet durable material of 15 to 40 mil HDPE woven coated liner strip which can be easily heat welded to the underlying polyethylene liner 12. One or more openings 25 may be provided in liner 12 to permit drilling equipment or other equipment to pass through liner 12.

As is best seen in FIG. 2, the elongate border sheet strip 13 is provided with a berm sleeve 14 along the outside elongate edge 15 and an apron 16 along the elongate inside edge 17, which is heat sealed in a liquid tight sealing manner to liner 12. A series of unconnected elongate resilient berm log segments 18 are slidably received withing sleeve 14.

For safety purposes, the external exposed surfaces 20 of sleeve 14 are a high visibility color, such as yellow, white or florescent orange.

The resilient berm log segments 18 are comprised of a plastic foam of polyolefin, urethane, polyether and/or polyester and they require no appendages or attachments of a different type of material, such as the base elements shown in combination with the foam log segments of US Patent Application Publication No. 2013/0121768. The encased foam log segments 18 are thus sufficiently resilient to permit large vehicles to drive over the berm 11 without damaging it and they spring back to their original height after passage of the vehicle.

The outer edge 21 of sleeve 14 is provided with a spaced series of grommets 22 for securing berm 11 to underlying ground 23 with anchor pins 24.

The drive-over berm 11 is fully assembled before shipment with the log segments 18 serially inserted and contained within the sleeve 14 of sheet strip 13. The log segments 18 are not connected to each other and thus may be freely slidably adjusted in position within sleeve 14 with gaps provided between adjacent ends of the log segments 18 whereby the border sheet strip 13 may then be folded at these gaps between log segments 18 whereby the entire preassembled berm 11 of 10 to 150 feet may be folded back and forth on itself and thereafter bundled in this folded compact state for easy storage and shipment in a preassembled condition.

At the drilling site, the liner 12 is first laid out and then the preassembled berm 11 is unfolded and laid about the perimeter of liner 12 to provide a completed perimeter berm 11. The corners of the berm 11 are formed by folding the sheet strip 13 at the desired corner locations. For this purpose, the log segments 18 may be readjusted within sleeve 14 to desired positions such that some adjacent log segments 18 are butting against each other, yet gaps between selected adjacent log segments are provided to permit corner folding of the boarder sheet strip 13 and its sleeve 14 at desired corner locations as shown.

When such corners for the berm 11 are formed, the inwardly extending apron 16 at the corners are folded back onto itself as indicated at the corner locations 30 in FIG. 1 and they are heat sealed to themselves so that the folded corners of apron 16 lie flat. the entire apron 16 is thereafter heat sealed to the underlying liner 12. Anchor pins 24 are also driven into the underlying earth through the grommets 22 to secure the outer perimeter of the berm 11. Also an HDPE patch 31 may be heat sealed over the seam formed between the adjacent terminating ends of the berm 11.

Referring next to FIG. 3, the berm 11 is in all respects identical to that illustrated in FIGS. 1 and 2, with the exception that the foam log segments 18 are of a triangular configuration as opposed to a rectangular or square configuration. As an alternative, the resilient log segments 18 may be constructed of unconnected elongate segments of an extruded plastic product which will flexibly collapse under the weight of a vehicle, yet rebound to its original configuration.

We claim:

1. A drive-over berm for use with a protective liner, the berm comprising:
an elongate liner border sheet strip of a liquid-impermeable material having a berm sleeve along an outside elongate edge and an apron along an elongate inside edge for sealed securement to an underlying liquid-impermeable protective liner; and
a series of unconnected elongate resilient berm log segments slidably received in said sleeve.

2. The drive-over berm of claim 1, wherein external exposed surfaces of said sleeve are a high visibility color.

3. The drive-over berm of claim 1, wherein said berm log segments are composed of a plastic foam.

4. The drive-over berm of claim 3, wherein said plastic foam is selected from the group consisting of polyolefin, urethane, polyether and polyester foams.

5. The drive-over berm of claim 1, wherein said apron is composed of a material which can be heat welded to the liner.

6. The drive-over berm of claim 5, wherein said apron material is polyethelene.

7. The drive-over berm of claim 1, including grommets along an outside edge of said sleeve for securing said berm to underlying ground with anchor pins.

8. A hazardous containment system comprising;
a liquid-impermeable liner;
a drive-over berm secured to the perimeter edge of said liner to thereby provide a hazardous containment pad;
said berm including an elongate border sheet strip of a liquid-impermeable material having a berm sleeve along an outside elongate edge and an apron along an elongate inside edge in liquid sealed securement to said liner; and
a series of unconnected elongate resilient berm log segments slidably received in said sleeve.

9. The hazardous containment system of claim 8, wherein external exposed surfaces of said sleeve are a high visibility color.

10. The hazardous containment system of claim 8, wherein said berm log segments are composed of a plastic foam.

11. The hazardous containment system of claim 10, wherein said plastic foam is selected from the group consisting of polyolefin, urethane, polyether and polyester foams.

12. The hazardous containment system of claim 8, wherein said apron is composed of a material which can be heat welded to the liner to provide said liquid sealed securement to said liner.

13. The hazardous containment system of claim 12, wherein said apron material is polyethelene.

14. The hazardous containment system of claim 8, including grommets along an outside edge of said sleeve for securing said berm to underlying ground with anchor pins.

15. A method of constructing a hazardous containment system comprising;
applying a protective liquid impervious liner sheet over a ground area to be protected;
forming a drive-over berm for the perimeter of the liner sheet with an elongate border sheet strip of a liquid-impervious material having a berm sleeve along an outside elongate edge and an apron along an elongate inside edge;
slidably inserting an unconnected series of elongate resilient berm log segments into said sleeve;
forming a drive-over berm on the perimeter of said liner sheet by positioning said log filled border sheet on and around the perimeter of said liner sheet with said apron facing inward by bending said border sheet between said unconnected logs to form corners where required; and
sealing said apron to said underlying liner sheet.

16. The method of claim 15, wherein said apron is secured to said underlying liner sheet by heat welding.

17. The method of claim 15, wherein the outer edge of said drive-over berm is provided with spaced grommets, and said outer edge is secured to underlying earth by driving anchor pins through said grommets.

18. The method of claim 15, wherein exposed surfaces of said sleeve are colored a high visibility color.

19. The method of claim 15, wherein said log segments are formed of a resilient plastic foam.

20. The method of claim 19, wherein said plastic foam is selected from the group consisting of polyolefin, urethane, polyether and polyester foams.

21. A drive-over berm for use with a protective liner, the berm comprising;
an elongate border sheet strip of a liquid-impermeable material having a berm sleeve along an elongate outside edge and an apron along an elongate inside edge for sealed securement to an underlying liquid-impermeable protective liner; and
at least one elongate resilient plastic foam log segment received in said sleeve;
said at least one log segment having no appendages or attachments of a different type of material.
